(19) United States
(12) Patent Application Publication
(10) Pub. No.: US 2023/0096253 A1
(43) Pub. Date: Mar. 30, 2023

(54) SYSTEMS AND METHODS FOR GENERATING NOTIFICATIONS

(71) Applicant: The Toronto-Dominion Bank, Toronto (CA)

(72) Inventors: Arthur Carroll CHOW, Markham (CA); Sangeeta MATHEW, Mississauga (CA); Angela CHOO, Toronto (CA)

(73) Assignee: The Toronto-Dominion Bank, Toronto (CA)

(21) Appl. No.: 17/485,869

(22) Filed: Sep. 27, 2021

(51) Int. Cl. G06Q 30/00; G06Q 30/02; H04L 29/08

(52) U.S. Cl. CPC G06Q 30/01; G06Q 30/0201; G06Q 30/0224; H04L 67/26

(57) ABSTRACT

A processor-implemented method is disclosed. The method includes: obtaining account data for a first resource account; determining candidate values for at least one account attribute based on the account data for the first resource account; determining, for each candidate value, a numerical indicator representing a degree of truth of the at least one account attribute having the candidate value; selectively identifying services associated with the first resource account based on the numerical indicators; and generating notifications of the identified services for presenting to an accountholder of the first resource account.

### TECHNICAL FIELD

The present disclosure relates to data processing systems and, in particular, to systems and methods for generating notifications.

### BACKGROUND

Businesses strive to present their customers with information about new or upcoming products. For example, merchants may maintain a mailing list of past and prospective customers, and send messages (e.g., emails) regarding product offers to contacts on the mailing list. More generally, promotional email campaigns may be sent to contacts, such as customers, subscribers, leads, etc. to promote a product or communicate certain information. These messages are typically sent in bulk to a large number of contacts, without customization. As a result, recipients may be led to either dismiss the messages as spam or unsubscribe from (or otherwise opt out of) the mailing lists.

### BRIEF DESCRIPTION OF DRAWINGS

Reference will now be made, by way of example, to the accompanying drawings which show example embodiments of the present application and in which:

FIG. 1 is a schematic diagram illustrating an operating environment of an example embodiment of the present disclosure;

FIG. 2A is a high-level schematic diagram of an example computing device;

FIG. 2B shows a simplified organization of software components stored in memory of the example computing device of FIG. 2A;

FIG. 3 shows, in flowchart form, an example method for generating notifications;

FIG. 4 shows, in flowchart form, an example method for performing fuzzy logic-based analysis of account data of a resource account when generating notifications;

FIG. 5 shows, in flowchart form, another example method for performing fuzzy logic-based analysis of account data of a resource account when generating notifications;

FIG. 6 shows, in flowchart form, an example method for processing bulk notifications of product offers; and

FIG. 7 shows, in flowchart form, another example method for processing bulk notifications of product offers.

Like reference numerals are used in the drawings to denote like elements and features.

### DETAILED DESCRIPTION OF EXAMPLE EMBODIMENTS

In one aspect, the present disclosure describes a computing system. The computing system includes a processor, a communications module coupled to the processor, and a memory coupled to the processor. The memory stores instructions that, when executed by the processor, configure the processor to: obtain account data for a first resource account; determine candidate values for at least one account attribute based on the account data for the first resource account; determine, for each candidate value, a numerical indicator representing a degree of truth of the at least one account attribute having the candidate value; selectively identify services associated with the first resource account based on the numerical indicators; and generate notifications of the identified services for presenting to an accountholder of the first resource account.

In some implementations, the at least one account attribute may comprise a country-of-origin of the accountholder and the candidate values may include a plurality of candidate countries.

In some implementations, the account data for the first resource account may include operations data of past account operations associated with the first resource account and determining the candidate values for the at least one account attribute may include identifying values of the at least one account attribute for the past account operations based on the operations data.

In some implementations, the operations data may include historical transactions data representing at least one past transaction associated with the first resource account.

In some implementations, the historical transactions data may indicate a location associated with the at least one past transaction.

In some implementations, the historical transactions data may include merchant data of a merchant associated with the at least one past transaction.

In some implementations, determining a numerical indicator for a candidate value may include determining at least one of a count or a frequency of account operations of the first resource account that are associated with the candidate value.

In some implementations, the account data for the first resource account may include identifying information for the accountholder and the candidate values may be determined based on the identifying information.

In some implementations, selectively identifying the services may include determining those services that are associated with one or more of the candidate values that satisfy defined criteria.

In some implementations, the defined criteria may include thresholds with which the numerical indicators are compared.

In another aspect, a processor-implemented method is disclosed. The method includes: obtaining account data for a first resource account; determining candidate values for at least one account attribute based on the account data for the first resource account; determining, for each candidate value, a numerical indicator representing a degree of truth of the at least one account attribute having the candidate value; selectively identifying services associated with the first resource account based on the numerical indicators; and generating notifications of the identified services for presenting to an accountholder of the first resource account.

In yet another aspect, a non-transitory computer readable storage medium is disclosed. The computer readable storage medium contains instructions thereon which, when executed by a processor, configure the processor to: obtain account data for a first resource account; determine candidate values for at least one account attribute based on the account data for the first resource account; determine, for each candidate value, a numerical indicator representing a degree of truth of the at least one account attribute having the candidate value; selectively identify services associated with the first resource account based on the numerical indicators; and generate notifications of the identified services for presenting to an accountholder of the first resource account.

Other example embodiments of the present disclosure will be apparent to those of ordinary skill in the art from a review of the following detailed descriptions in conjunction with the drawings.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

Businesses often collect information from customers to inform their future marketing endeavors. As a specific example, a merchant may collect contact information from customers, subscribers, leads, etc., and generate a mailing list using the collected information. Email campaigns may be sent to the contacts on a mailing list to promote new or upcoming products or to communicate certain information. A merchant may, for example, send emails containing sales and product release information to subscribed members. These emails are typically sent in bulk to all or a large number of the contacts on a mailing list, without customization of the message. For example, all subscribers of a merchant's mailing list may receive the same promotional emails from the merchant. When bulk messages are not customized or targeted to specific recipients, the messages may have an undesirable effect. In particular, recipients may be led to either dismiss the messages as spam or unsubscribe from (or otherwise opt out of) the mailing lists.

The present application discloses solutions for sending bulk messages on a targeted basis. Specifically, a messaging system that generates targeted messages for accountholders of resource accounts is described. The disclosed system selectively generates notifications for providing to accountholders. In particular, the system may perform a fuzzy logic-based analysis of account data of resource accounts and determine the messages (e.g., notifications) that are suitable for sending to the accountholders based on the analysis. By way of example, the system may perform analysis of account data of a resource account and selectively identify services or other products for promoting (e.g., by means of notifications) to the accountholder. The identified services may be conveyed to the accountholder, for example, via one or more notifications. The disclosed system may thus process sending of bulk messages such that messages are transmitted to only those contacts for whom the messages are deemed as suitable based on automated analysis of account data of resource accounts associated with the contacts.

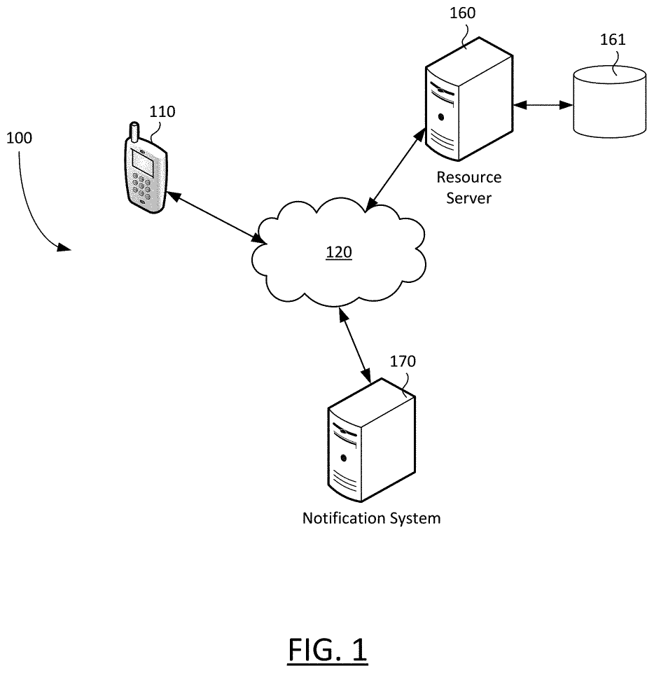

Reference is first made to FIG. 1, which is a schematic diagram illustrating an operating environment of an example embodiment. FIG. 1 illustrates exemplary components of a system 100 for generating and sending notifications. As a specific example, the system 100 of FIG. 1 may be implemented to facilitate sending of bulk messages to a plurality of recipients on a targeted basis.

As shown in FIG. 1, a resource server 160 (which may also be referred to as a server computing system) and client device 110 communicate via the network 120. The client device 110 is a computing device associated with an entity having resources that are associated with the resource server 160. For example, the resource server 160 may be a server that is operated by a financial institution and the client device 110 may be associated with a customer of the financial institution. The client device 110 may take a variety of forms including, for example, a mobile communication device such as a smartphone, a tablet computer, a wearable computer such as a head-mounted display or smartwatch, a laptop or desktop computer, or a computing device of another type.

The resource server 160 may track, manage, and maintain resources, make lending decisions, and/or lend resources to a borrower (e.g., customer) entity. The resources may, for example, be computing resources, such as memory or processor cycles. By way of further example, the resources may include stored value, such as fiat currency, which may be represented in a database. For example, the resource server 160 may be coupled to a database 161, which may be provided in secure storage. The secure storage may be provided internally within the resource server 160 or externally. The secure storage may, for example, be provided remotely from the resource server 160. For example, the secure storage may include one or more data centers. The data centers may, for example, store data with bank-grade security.

The database 161 may include data records for a plurality of resource accounts and at least some of the data records may define a quantity of resources associated with an entity. For example, the entity that is associated with the client device 110 may be associated with a resource account having one or more data records in the database. The data records may reflect a quantity of stored resources that are associated with the customer entity. Such resources may include owned resources and, in at least some embodiments, borrowed resources (e.g., resources available on credit). The quantity of resources that are available to or associated with an entity may be reflected by a balance defined in an associated data record such as, for example, a bank balance.

FIG. 1 also illustrates a notification system 170. The notification system 170 is a computing system that provides a means of delivering messages to recipients. The notification system 170 may be configured to generate various types of messages, such as in-app notifications, emails, SMS, and the like. Additionally, or alternatively, the notification system 170 may facilitate transmitting messages that are generated by other message sources. For example, the notification system 170 may obtain messages from one or more message sources and selectively transmit the messages to various recipients in accordance with defined rules for message transmission.

In at least some embodiments, the notification system 170 may be linked a specific entity. In particular, the notification system 170 may be configured to only generate and/or transmit messages that are associated with a specific entity. For example, the notification system 170 may be associated with a merchant, and messages generated by the notification system 170 may be transmitted only to customers (or subscribers, etc.) of the merchant. In some other embodiments, the notification system 170 may handle messages that are associated with multiple different entities. For example, the notification system 170 may process sending of bulk messages for a plurality of merchants.

The notification system 170 is communicably coupled to the resource server 160. Specifically, the notification system 170 is configured to access account data of resource accounts that are managed by the resource server 160. As will be described in greater detail below, the notification system 170 may generate and/or send targeted messages for accountholders of resource accounts at the resource server 160 based on analysis of account data of the resource accounts.

While FIG. 1 illustrates the resource server 160 and the notification system 170 as being independent components of the system 100, it will be understood that the functions of the notification system 170 may be implemented by the resource server 160. For example, the resource server 160 may include (or have access to) a notification engine that is configured to generate and/or send messages to entities (e.g., accountholders) that are associated with one or more resource accounts at the resource server 160. The notification engine may, for example, be implemented as a software module of the resource server 160.

As described above, the client device 110, the resource server 160, and the notification system 170 may be computing systems. The client device 110, the resource server 160, and the notification system 170 may be in geographically disparate locations. Put differently, the client device 110 may be remote from at least one of the resource server 160 and the notification system 170.

The network 120 is a computer network. In some embodiments, the network 120 may be an internetwork such as may be formed of one or more interconnected computer networks. For example, the network 120 may be or may include an Ethernet network, an asynchronous transfer mode (ATM) network, a wireless network, or the like.

In the example of FIG. 1, the resource server 160 may provide both data transfer processing (e.g., bill payment) and data holding (e.g., banking) functions. That is, the resource server 160 may be both a financial institution server and also a bill payment processing server. The resource server 160 may, in some embodiments, be a proxy server, serving as an intermediary for requests for client devices 110 seeking resources from other servers.

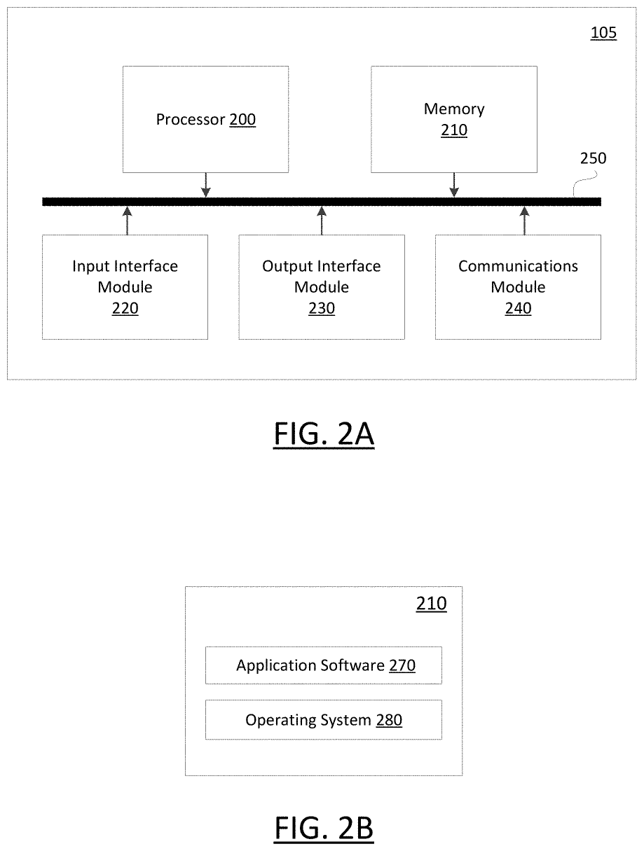

FIG. 2A is a high-level operation diagram of the example computing device 105. In at least some embodiments, the example computing device 105 may be exemplary of one or more of the client device 110, the resource server 160, and the notification system 170. The example computing device 105 includes a variety of modules. For example, as illustrated, the example computing device 105, may include a processor 200, a memory 210, an input interface module 220, an output interface module 230, and a communications module 240. As illustrated, the foregoing example modules of the example computing device 105 are in communication over a bus 250.

The processor 200 is a hardware processor. Processor 200 may, for example, be one or more ARM, Intel x86, PowerPC processors or the like.

The memory 210 allows data to be stored and retrieved. The memory 210 may include, for example, random access memory, read-only memory, and persistent storage. Persistent storage may be, for example, flash memory, a solid-state drive or the like. Read-only memory and persistent storage are a computer-readable medium. A computer-readable medium may be organized using a file system such as may be administered by an operating system governing overall operation of the example computing device 105.

The input interface module 220 allows the example computing device 105 to receive input signals. Input signals may, for example, correspond to input received from a user. The input interface module 220 may serve to interconnect the example computing device 105 with one or more input devices. Input signals may be received from input devices by the input interface module 220. Input devices may, for example, include one or more of a touchscreen input, keyboard, trackball or the like. In some embodiments, all or a portion of the input interface module 220 may be integrated with an input device. For example, the input interface module 220 may be integrated with one of the aforementioned example input devices.

The output interface module 230 allows the example computing device 105 to provide output signals. Some output signals may, for example allow provision of output to a user. The output interface module 230 may serve to interconnect the example computing device 105 with one or more output devices. Output signals may be sent to output devices by output interface module 230. Output devices may include, for example, a display screen such as, for example, a liquid crystal display (LCD), a touchscreen display. Additionally, or alternatively, output devices may include devices other than screens such as, for example, a speaker, indicator lamps (such as for, example, light-emitting diodes (LEDs)), and printers. In some embodiments, all or a portion of the output interface module 230 may be integrated with an output device. For example, the output interface module 230 may be integrated with one of the aforementioned example output devices.

The communications module 240 allows the example computing device 105 to communicate with other electronic devices and/or various communications networks. For example, the communications module 240 may allow the example computing device 105 to send or receive communications signals. Communications signals may be sent or received according to one or more protocols or according to one or more standards. For example, the communications module 240 may allow the example computing device 105 to communicate via a cellular data network, such as for example, according to one or more standards such as, for example, Global System for Mobile Communications (GSM), Code Division Multiple Access (CDMA), Evolution Data Optimized (EVDO), Long-term Evolution (LTE) or the like. Additionally, or alternatively, the communications module 240 may allow the example computing device 105 to communicate using near-field communication (NFC), via Wi-Fi (™), using Bluetooth (™) or via some combination of one or more networks or protocols. Contactless payments may be made using NFC. In some embodiments, all or a portion of the communications module 240 may be integrated into a component of the example computing device 105. For example, the communications module may be integrated into a communications chipset.

Software comprising instructions is executed by the processor 200 from a computer-readable medium. For example, software may be loaded into random-access memory from persistent storage of memory 210. Additionally, or alternatively, instructions may be executed by the processor 200 directly from read-only memory of memory 210.

FIG. 2B depicts a simplified organization of software components stored in memory 210 of the example computing device 105. As illustrated, these software components may include application software 270 and an operating system 280.

The application software 270 adapts the example computing device 105, in combination with the operating system 280, to operate as a device performing particular functions. While a single application software 270 is illustrated in FIG. 2B, in operation, the memory 210 may include more than one application software 270 and different application software 270 may perform different operations.

The operating system 280 is software. The operating system 280 allows the application software 270 to access the processor 200, the memory 210, the input interface module 220, the output interface module 230 and the communications module 240. The operating system 280 may be, for example, Apple iOS™, Google™'s Android™, Linux™, Microsoft™ Windows™, or the like.

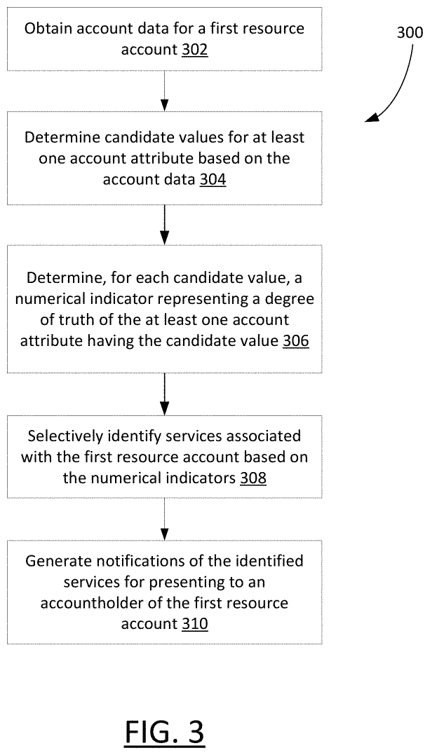

Reference is made to FIG. 3, which shows, in flowchart form, an example method 300 for generating notifications. The method 300 may enable a computing system to generate and send bulk messages to a plurality of recipients on a targeted basis. Specifically, in accordance with the method 300, targeted notifications for accountholders of resource accounts may be generated based on analysis of account data of the resource accounts. Operations 302 and onward are performed by one or more processors of a computing device such as, for example, the processor 200 (FIG. 2) of a suitably configured instance of the example computing device 105 (FIG. 2). The method 300 may be implemented, for example, by a computing system, such as the notification system 170, that is configured for handling notifications in connection with one or more data records (and associated resource accounts) of a database.

A computing system may receive requests to process bulk messages. By way of example, a merchant may request that a notification system generate and selectively send messages (e.g., promotional emails, etc.) to customers of the merchant. More generally, a computing system may be requested to process bulk messages for sending to recipient entities that are associated with one or more resource accounts. For example, the bulk messages may be requested to be sent on a targeted basis to accountholders of the resource accounts.

The selection of bulk messages to provide to an accountholder is made based on the account data associated with their resource account. In operation 302, the computing system obtains account data for a first resource account. The account data may be stored in one or more data records associated with the first resource account. The account data may include behavioral and non-behavioral data relating to the accountholder of the first resource account. In at least some embodiments, the account data includes operations data of past account operations associated with the first resource account. For example, the first resource account may be a bank account that is managed by a financial institution, and the account data of the first resource account may include historical transactions data of the accountholder. That is, the account data may include transactions data associated with past transactions conducted by the accountholder in connection with the first resource account. The historical transactions data may indicate, for each of one or more past transactions, various information about the transaction, such as transaction type, location, merchant data (e.g., name of merchant, branch number, etc.), date and/or time, transaction amount, and the like. The account data may also include other information that is representative of the accountholder's engagement with their resource account, such as account changes (e.g., new or cancelled data records, increase in resource borrowing limit, etc.), profile updates, and the like.

Additionally, or alternatively, the account data of the first resource account may include non-behavioral data. Examples of non-behavioral data include resource type, account settings and preferences, and profile information (e.g., name, age, gender, address, etc.) of the accountholder. The account data, including behavioral and non-behavioral data, of the first resource account are inputs to a decision process for selecting the bulk messages that are suitable for providing to the accountholder (or other entity) associated with the first resource account.

In operation 304, the computing system determines candidate values for at least one account attribute of the first resource account based on the account data. An account attribute is an attribute, or property, associated with a resource account. In particular, an account attribute may be an attribute for which a value is not expressly provided or defined, by the accountholder or otherwise. That is, the value of an account attribute is determined derivatively. For example, an attribute value may be determined based on analysis of account data (e.g., historical transactions data, etc.) of a resource account. Examples of account attributes may include: country of residence, nationality, employment status, etc. of the accountholder; total value of assets; type of resource; and the like.

In some embodiments, the at least one account attribute may be identified as part of a request to process bulk messages (e.g., notifications). Specifically, a request to process a bulk message may include an indication of one or more account attributes that are relevant for determining whether the bulk message should be provided for a resource account. The at least one account attribute is used in assessing the suitability of a bulk message for certain recipients. For example, the at least one account attribute may relate to an attribute or characteristic of a product that is desired to be promoted to certain customers by means of a bulk message, e.g., a promotional email campaign. Alternatively, the relevant account attributes for a bulk message may be determined automatically based on analysis of the content of the message, such as product data for a promoted product. That is, the at least one account attribute may not be manually identified; instead, it may be determined derivatively based on message content of a bulk message.

For the at least one account attribute, the computing system determines one or more candidate values. The term “candidate values” refers to values that are regarded as suitable or likely to be a correct value for an account attribute. By way of example, if the country-of-origin of the accountholder is determined to be a relevant account attribute for a bulk message, the computing system may determine one or more candidate values (i.e., candidate countries, at least one of which may be the actual country-of-origin of the accountholder). As another example, if the demographic to which the accountholder belongs is determined to be a relevant account attribute, the computing system may determine a specific age or an age group for the accountholder.

The computing system determines the candidate values based on account data of the first resource account. In particular, the account data may include operations data of past account operations associated with the first resource account, and the candidate values may be determined based on analysis of the operations data. More generally, the candidate values for the at least one account attribute may be determined based on analyzing behavioral data representing the accountholder's past engagement with the first resource account.

As an illustrative example, a relevant account attribute for a given bulk message may be the country-of-origin of the accountholder. For example, the bulk message may be a promotional message that is intended for recipients that are born in, or otherwise have a strong connection to, a particular country. The candidate values (i.e., candidate countries) for this account attribute may be determined by identifying the locations associated with past account operations of the first resource account. The operations data may include historical transactions data associated with past transactions conducted in connection with the first resource account. The historical transactions data includes location data (i.e., country, state, city, etc.) identifying the locations associated with the past transactions. Based on the location data for all or a subset of the past transactions, the computing system may derive a list of one or more candidate values for the accountholder's country-of-origin. The list may include, for example, all of the identified locations associated with past transactions. Alternatively, the list may include only a select number of the identified locations; for example, the list may include a defined number of locations that are most frequently associated with past transactions. Examples of transactions that may be relevant for identifying candidates for country-of-origin include: purchase transactions at an international or cultural grocery store; transactions in a foreign country; payroll (check or direct) deposits; foreign currency transactions or conversions; and remittances or other foreign transfers of funds.

In operation 306, the computing system determines, for each candidate value of the at least one account attribute, a numerical indicator representing a degree of truth of the at least one account attribute having the candidate value. For each candidate value, the numerical indicator may be modeled using a membership function associated with the candidate value. In some embodiments, the membership function may be a function from the set of all account operations (e.g., past transactions) associated with the first resource account to an interval of numbers (e.g., the real unit interval [0,1]). For example, the membership function for a candidate value may map the set of past transactions conducted in connection with the first resource account to a value (i.e., a numerical indicator) in the interval [0,1] that is representative of a degree of truth of the account attribute having the candidate value. In the example of “country-of-origin” as a relevant account attribute, the computing system may define a membership function for each candidate country, and the output of each membership function may be a numerical indicator representing the degree of truth of the first resource account being associated with the corresponding candidate country.

The numerical indicators for the candidate values may be determined in accordance with predefined rules. In at least some embodiments, the rules may be represented by the defined membership functions associated with the candidate values. For example, the computing system may access stored rules (or logic) for computing numerical indicators and define the membership functions based on the rules/logic. In particular, each membership function may be defined such that the set of account operations of the first resource account are mapped to a numerical indicator based on the predefined rules. As an example, the rules may specify, for each of one or more account operations, a value to assign (e.g., 0 or 1) to the account operation, and the numerical indicator for a candidate value may be computed using a weighted sum method based on the assigned values. In the example of “county of origin” as an account attribute, if the location data for an account operation, such as a past transaction, indicates that the account operation is associated with a specific candidate country, the membership function associated with the candidate country may evaluate to a value of 1 when the account operation is provided as the input. Once the values have been assigned to the account operations associated with the first resource account, a weighted sum (or weighted average, etc.) over the set of the account operations may be computed to obtain the numerical indicator for the candidate country.

In some embodiments, the numerical indicator for a candidate value may be determined based on determining at least one of a count or a frequency of account operations of the first resource account that are associated with the candidate value. In particular, one or both of count and frequency data for the account operations that are associated with a candidate value (e.g., operations having location data indicating a candidate country as the associated location) may be monitored and used to inform the determination of the numerical indicator for the candidate value.

In operation 308, the computing system selectively identifies services associated with the first resource account based on the numerical indicators. As explained above, the numerical indicator associated with a candidate value represents a degree of truth of an account attribute having the candidate value; a high degree of truth may indicate that the account attribute may indeed have that candidate value, and a low degree of truth may indicate that the candidate value is likely an incorrect value for the account attribute. Accordingly, the computing system may determine a single value for the account attribute based on the numerical indicators. In at least some embodiments, the computing system may identify the candidate value that is associated with the highest degree of truth (i.e., highest numerical indicator) and set the account attribute as the identified candidate value. For example, among the candidate countries for the country-of-origin of the accountholder, the computing system may select the country that is associated with the highest numerical indicator value as the actual country-of-origin.

Upon determining and/or setting the value of the at least one account attribute, the computing system identifies services that are relevant for the selected attribute value. For example, when a country-of-origin of the accountholder is determined, the computing system may identify services, such as an international remittance platform, one or more application-related features, resource transfer mechanisms, etc., that may be available to the accountholder based on the determined country-of-origin. The services may be offered by a single service provider or multiple different service providers. The identified services are services that are determined to be suitable for the accountholder based on the analysis of account data associated with the first resource account.

The computing system may then generate notifications indicating the identified services for presenting to the accountholder of the first resource account, in operation 310. The notifications may be in various different forms, such as in-app notifications, emails, SMS, and the like. The notifications may be provided to the accountholder by the computing system. For example, the notifications may be transmitted to a computing device associated with the accountholder, or provided via a service (e.g., website) that is accessible by the accountholder.

As described above with reference to FIG. 3, bulk messages may be selectively sent to recipients based on analysis of account data of resource accounts associated with the recipients. Specifically, at least one account attribute that is relevant to a bulk message may be identified, and a value of the account attribute for a recipient's account may be determined through analysis of account data. A bulk message may be sent to a recipient only when the attribute value suggests that the message is relevant or suitable for the recipient. In particular, a bulk message that includes product information of products (e.g., services, physical goods, etc.) for promoting to a particular recipient may be sent to the recipient based on determining that the products are associated with the attribute value for the recipient's account.

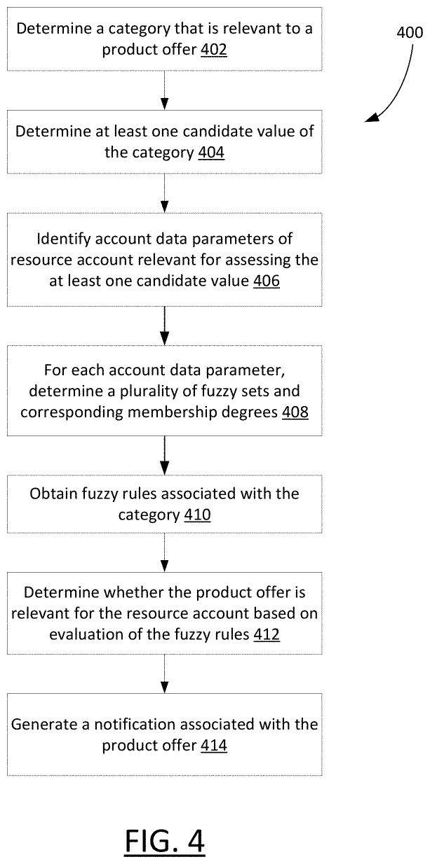

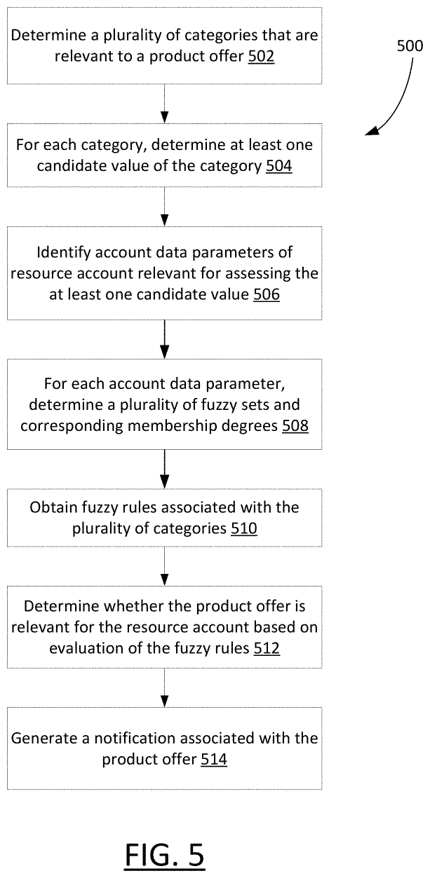

FIGS. 4 and 5 illustrate mechanisms for evaluating account data. Specifically, methods that employ fuzzy logic in analyzing account data are described. Reference is first made to FIG. 4, which shows, in flowchart form, an example method 400 for performing analysis of account data of a resource account when generating notifications. The method 400 may enable a computing system to generate and send bulk messages to a plurality of recipients on a targeted basis. Specifically, in accordance with the method 400, targeted notifications for accountholders of resource accounts may be generated based on analysis of account data of the resource accounts. Operations 402 and onward are performed by one or more processors of a computing device such as, for example, the processor 200 (FIG. 2) of a suitably configured instance of the example computing device 105 (FIG. 2). The method 400 may be implemented, for example, by a computing system, such as the notification system 170, that is configured for handling notifications in connection with one or more data records (and associated resource accounts) of a database. The operations of method 400 may be performed in addition to, or as alternatives of, one or more operations of method 300.

A computing system may be requested to process bulk notifications for sending to one or more recipients. Specifically, a merchant may request that a bulk notification relating to a product offer be sent to customers (or other subscribers) of the merchant on a targeted basis. In operation 402, the computing system determines at least one category that is relevant to the product offer. The product may, for example, be a physical good or a service that is offered by the merchant. Accordingly, the at least one category may relate to product data of the product associated with the offer. In particular, the at least one category may be a factor for determining whether a bulk notification is relevant for a recipient/customer. As an example, the at least one category may be “country” where the product is offered. The “country” associated with a resource account may, for example, qualify or disqualify the accountholder (or other entity) associated with the resource account from receiving a bulk notification in connection with the product offer.

Upon determining a relevant category for the product offer, the computing system performs analysis of account data of a resource account. The resource account may, for example, be an account associated with a prospective recipient of the bulk notification. In operation 404, the computing system determines at least one candidate value for the category. In particular, one or more candidate values are determined based on the account data of the resource account. A candidate value for a category refers to a value that is regarded as suitable or likely to be a correct value of the category for the resource account. The account data may include one or both of behavioral and non-behavioral data. For example, the account data may include operations data of past account operations associated with the resource account. The operations data may include historical transactions data describing past transactions conducted in connection with the resource account. As another example, the account data may include profile information, such as name, age, and the like, of the accountholder of the resource account.

As an illustrative example, if the category determined in operation 402 is “country”, the computing system may identify one or more candidate values for “country” based on operations data of account operations associated with the resource account. In at least some embodiments, operations data may include location data (e.g., country, state, city) for the account operation, and a country may be identified from the location data. The computing system may thus derive a list of one or more candidate values for “country” based on location data for all or a subset of the account operations associated with the resource account.

The computing system determines a value of the category through a fuzzy logic-based evaluation of the account data of the resource account. In particular, one of the candidate values is selected and determined to be the value of the category for the resource account based on the evaluation. In operation 406, the computing system identifies account data parameters of the resource account that are relevant for assessing the candidate values. For each of the candidate values of the category, the computing system may use a fuzzy logic-based assessment of one or more account data parameters in determining a “true” value of the category for the resource account. In at least some embodiments, the account data parameters relate to account operations associated with the resource account. In particular, the account data parameters may be defined based on one or more past account operations that are determined to be relevant for assessing the category.

Using the above example of “country” as a category, the computing system may determine various account data parameters based on past account operations whose operations data indicates locations associated with the operations. Examples of such account data parameters include: frequency of transactions at an international or cultural establishment (e.g., grocery store); total amount spent at an international/cultural establishment over a defined period of time; total amount of remittances or other foreign transfers of funds over a defined period of time; number of foreign currency transactions or conversions; frequency of payroll (check or direct) deposits; and the like.

For each of the defined account data parameters, the computing system determines a plurality of fuzzy sets and corresponding membership degrees, in operation 408. A fuzzy set may be a vaguely defined set that is associated with a linguistic value or descriptor (e.g., “rare”, “casual”, “frequent”, “small”, “large”, etc.). The computing system may define fuzzy sets that correspond to suitable descriptors of the associated account data parameter. By way of example, for an account data parameter “frequency of transactions at an international or cultural establishment”, the fuzzy sets may be associated with the linguistic descriptors “rare”, “casual”, and “frequent”. As another example, for an account data parameter “total amount of remittances”, the fuzzy sets may be associated with the linguistic descriptors “small”, “normal”, and “large”. The fuzzy sets allow for modelling vagueness associated with the account data parameters.

Once the fuzzy sets for the account data parameters are defined, the membership degrees corresponding to the fuzzy sets are determined. Specifically, for each fuzzy set, a numerical value representing a degree of membership of the account data parameter in the fuzzy set is determined. The membership degree for a fuzzy set may, for example, be a real number in a defined number interval (e.g., the real unit interval [0,1]). By way of illustration, for the account data parameter “frequency of transactions at an international/cultural establishment”, the membership degrees corresponding to the defined fuzzy sets, i.e., (“rare”, “casual”, “frequent”), may be (0.1, 0.3, 0.7). That is, the “frequency” may have 0.1 membership in the fuzzy set “rare”, 0.3 membership in the fuzzy set “casual”, and 0.7 membership in the fuzzy set “frequent”. In this way, the computing system assigns a degree of membership of the account data parameter for each fuzzy set.

In operation 410, the computing system obtains fuzzy rules associated with the category. The fuzzy rules are predefined rules which may be executed to obtain output truth values based on input or computed truth values. The output truth values, or “fuzzy truth values”, relate to the value of the category. In particular, the computing system may employ the fuzzy rules in determining a final output value of the category for the resource account based on the membership degrees assigned to each of the defined fuzzy sets. For example, for each account data parameter, a single value may be derived from the membership degrees for the fuzzy sets associated with the account data parameter. The values for all or a plurality of the account data parameters associated with a category can be used to determine a final output value of the category.

This fuzzy logic-based evaluation process may be performed for the account data parameters identified in operation 406. In particular, the fuzzification of input values into fuzzy membership functions may be performed for all or a plurality of the account data parameters that are relevant for determining the category. The final output value of the category for the resource account may be determined based on the membership degrees corresponding to the fuzzy sets associated with the plurality of account data parameters.

As an illustrative example, the account data parameter “frequency of transactions at an international or cultural establishment” may have (0.1, 0.3, 0.9) as the membership degrees corresponding to the defined fuzzy sets, i.e., (“rare”, “casual”, “frequent”). The computing system may determine the value of this account data parameter as “quite frequent” which may map to a specific truth value in connection with the resource account being associated with a particular country. In a similar manner, by deriving values for all or a subset of the account data parameters associated with a category, the computing system may obtain mappings to truth values that are indicative of the resource account being associated with a particular country. The final output value of the category may be obtained by the computing system based on said truth values, using predefined rules.

The computing system determines whether the product offer (and, by association, the bulk notification) is relevant for the resource account based on the evaluation of the fuzzy rules, in operation 412. Specifically, the computing system may compare the final output value of the category for the resource account with the corresponding value of the category associated with the bulk notification. The category may, for example, be an attribute or characteristic of a product that is used for assessing relevance or suitability of the product for a recipient (i.e., accountholder of the resource account).

More generally, the computing system may determine a plurality of categories (e.g., product attributes) that are relevant for assessing suitability of a product for a recipient, and perform similar fuzzy logic-based evaluation of account data. The final output values of the categories for the resource account can be compared with corresponding values associated with the product when assessing whether to send a bulk notification relating to the product (e.g., a promotional email campaign for the product) to the recipient.

If the product offer/bulk notification is determined to be relevant for the resource account, the computing system generates and/or presents the bulk notification to the accountholder of the resource account, in operation 414. For example, if the output value of the category (e.g., “country”) for the resource account matches the corresponding value of the category associated with the bulk notification, the computing system may determine that the bulk notification is relevant for the resource account, and the notification may be provided to the accountholder (or other entity) associated with the resource account.

Reference is made to FIG. 5, which shows, in flowchart form, another example method 500 for performing analysis of account data of a resource account when generating notifications. The method 500 may be implemented by a computing system, such as the notification system 170, that is configured for handling notifications in connection with one or more data records (and associated resource accounts) of a database. The operations of method 500 may be performed in addition to, or as alternatives of, one or more operations of methods 300 and 400.

In operation 502, the computing system may determine a plurality of categories that are relevant to a product offer associated with a bulk notification. Whereas only a single category is identified in operation 402 of method 400, the computing system may identify multiple different categories (e.g., country, age group, employment status, etc.) which may be relevant for assessing the suitability of the product offer for a resource account.

For each of the categories, the computing system determines at least one candidate value of the category, in operation 504. Operations 504, 506, 508 and 510 correspond to operations 404, 406, 408 and 410, respectively, of method 400. In particular, the computing system performs a fuzzy logic-based evaluation of account data by identifying one or more account data parameters of a resource account that are relevant for assessing candidate values of the categories and determining membership degrees corresponding to fuzzy sets for each of the account data parameters. Different account data parameters may be identified for the different categories and, accordingly, different fuzzy sets may be defined by the computing system as part of fuzzification of input values (e.g., account data of the resource account). The membership degrees corresponding to defined fuzzy sets are determined based on account data of the resource account. Specifically, the membership degrees may be determined based on account operations (e.g., historical transactions data) associated with the resource account.

For each account data parameter, the computing system may determine a value of the account data parameter based on the membership degrees. The determined value may map to a specific truth value in connection with the resource account being associated with a particular category. In a similar manner, by deriving values for all or a subset of the account data parameters associated with a category, the computing system may obtain mappings to truth values that are indicative of the resource account being associated with a particular category. The final output value of the category may be obtained by the computing system based on said truth values, using predefined rules. The relevance/suitability of a product offer (and/or bulk notification) for a recipient may be determined by the computing system by obtaining the final output values of all or a subset of the categories associated with the product offer. The computing system may compare the final output values of the categories to corresponding values of the categories for the product offer/bulk notification and render a decision as to whether the product offer/bulk notification is relevant for the resource account.

In operation 512, as described above, the computing system determines whether the product offer is relevant for the resource account based on evaluation of fuzzy rules for all of the plurality of categories associated with the product offer. If the product offer is determined to be relevant/suitable for the resource account, the computing system generates and/or presents the bulk notification to the accountholder (or other entity) associated with the resource account, in operation 514.

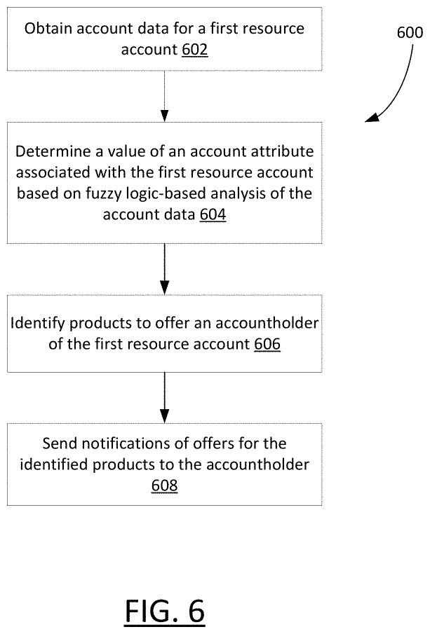

Reference is made to FIG. 6, which shows, in flowchart form, an example method 600 for processing bulk notifications of product offers. The method 600 may enable a computing system to generate and send bulk messages to a plurality of recipients on a targeted basis. Specifically, in accordance with the method 600, targeted notifications for accountholders of resource accounts may be generated based on analysis of account data of the resource accounts. Operations 602 and onward are performed by one or more processors of a computing device such as, for example, the processor 200 (FIG. 2) of a suitably configured instance of the example computing device 105 (FIG. 2). The method 600 may be implemented, for example, by a computing system, such as the notification system 170, that is configured for handling notifications in connection with one or more data records (and associated resource accounts) of a database. The operations of method 600 may be performed in addition to, or as alternatives of, one or more operations of methods 300, 400 and 500.

When a notification system receives requests to process bulk notifications for sending to a recipient, the system may first obtain account data of a resource account associated with the recipient, in operation 602. The account data may include, for example, behavioral and non-behavioral data of the accountholder (or other entity) associated with the resource account. For example, the account data may include operations data for account operations, such as historical transactions data, associated with the resource account.

The computing system may then determine values of one or more account attributes associated with the first resource account, in operation 604. The values of the account attributes may be determined through a fuzzy logic-based analysis of the account data. In particular, the final output value of each of one or more account attributes may be determined in accordance with the techniques described above in relation to account data evaluation using fuzzy logic.

In operation 606, the computing system may identify products to offer to an accountholder of the resource account. Specifically, the computing system may obtain product information from merchants offering their products, and determine which of the products on offer are relevant and/or suitable for the accountholder. The determination of relevance/suitability may be based on the output values of the one or more account attributes (e.g., country of residence, age group, etc.) associated with the resource account.

Upon identifying the products that are relevant and/or suitable, the computing system presents notifications indicating offers for the identified products to the accountholder, in operation 608. For example, the computing system may transmit messages, such as in-app notifications, emails, SMS, etc., to a computing device associated with the accountholder. Additionally, or alternatively, the notifications may be provided via a service (e.g., website) that is accessible by the accountholder.

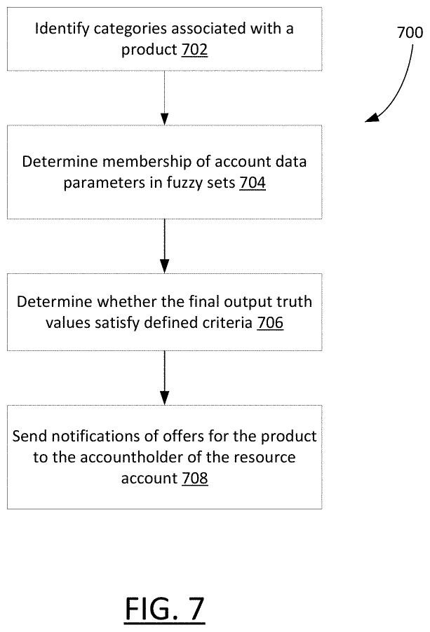

Reference is made to FIG. 7, which shows, in flowchart form, another example method 700 for processing bulk notifications of product offers. The method 700 may enable a computing system to generate and send bulk messages to a plurality of recipients on a targeted basis. Specifically, in accordance with the method 700, targeted notifications for accountholders of resource accounts may be generated based on analysis of account data of the resource accounts. Operations 702 and onward are performed by one or more processors of a computing device such as, for example, the processor 200 (FIG. 2) of a suitably configured instance of the example computing device 105 (FIG. 2). The method 700 may be implemented, for example, by a computing system, such as the notification system 170, that is configured for handling notifications in connection with one or more data records (and associated resource accounts) of a database.

Whereas, in method 600, relevant/suitable products for a particular resource account are identified based on account attribute values that are determined through fuzzy logic-based analysis, in method 700 the computing system determines whether a resource account is suitable for receiving notifications of offers for a particular product. That is, the method 700 is a product-centric approach to assessing suitability of a product offer for a resource account, while the method 600 is an account-centric approach for assessing suitability.

In operation 702, the computing system first identifies categories that are associated with a product on offer. The categories may relate to, for example, product attributes (or characteristics) of the product. Examples of categories may include: product type; country where product is offered and/or used; intended customers; and the like.

In operation 704, the computing system identifies a plurality of account data parameters and defines relevant fuzzy sets for each of the account data parameters. The account data parameters may be determined based on account data of the resource account. In particular, the account data parameters may be derived from operations data of past account operations (e.g., historical transactions data) associated with the resource account. The account data parameters and the definition of corresponding fuzzy sets for the account data parameters may be performed in a similar manner as described above with respect to methods 400 and 500. Specifically, the computing system may determine the degree of membership to the defined fuzzy sets through fuzzification of input values into membership functions.

The computing system then determines whether the final output truth values of the account data parameter satisfy defined criteria, in operation 706. For example, the final output truth value may be compared to a defined threshold; if the value equals or exceeds the threshold, the value may be determined to satisfy the criteria. This criteria-based evaluation of the final output truth value may be performed in connection with a plurality of categories which may be identified in operation 702. In particular, a particular product may be determined to be relevant/suitable for notifying to an accountholder of a resource account if the final output values of account data parameters (or values of categories that are determined based on such final output values) match the identified categories associated with the product.

In response to determining that the particular product is relevant/suitable for the accountholder, the computing system presents notifications of offers for the product to the accountholder, in operation 708. The notifications may be sent as messages or provided via a service (e.g., a website) that is accessible by the accountholder.

The various embodiments presented above are merely examples and are in no way meant to limit the scope of this application. Variations of the innovations described herein will be apparent to persons of ordinary skill in the art, such variations being within the intended scope of the present application. In particular, features from one or more of the above-described example embodiments may be selected to create alternative example embodiments including a sub-combination of features which may not be explicitly described above. In addition, features from one or more of the above-described example embodiments may be selected and combined to create alternative example embodiments including a combination of features which may not be explicitly described above. Features suitable for such combinations and sub-combinations would be readily apparent to persons skilled in the art upon review of the present application as a whole. The subject matter described herein and in the recited claims intends to cover and embrace all suitable changes in technology.

1. A computing system, comprising:
a processor;
a communications module coupled to the processor; and
a memory coupled to the processor, the memory storing instructions that, when executed, configure the processor to:
obtain account data for a first resource account;
determine candidate values for at least one account attribute based on the account data for the first resource account;
determine, for each candidate value, a numerical indicator representing a degree of membership of the at least one account attribute having the candidate value;
selectively identify services associated with the first resource account based on the numerical indicators; and
generate notifications of the identified services for presenting to an accountholder of the first resource account.

2. The computing system of claim 1, wherein the at least one account attribute comprises a country-of-origin of the accountholder and wherein the candidate values include a plurality of candidate countries.

3. The computing system of claim 1, wherein the account data for the first resource account includes operations data of past account operations associated with the first resource account and wherein determining the candidate values for the at least one account attribute comprises identifying values of the at least one account attribute for the past account operations based on the operations data.

4. The computing system of claim 3, wherein the operations data comprise historical transactions data representing at least one past transaction associated with the first resource account.

5. The computing system of claim 4, wherein the historical transactions data indicates a location associated with the at least one past transaction.

6. The computing system of claim 4, wherein the historical transactions data comprises merchant data of a merchant associated with the at least one past transaction.

7. The computing system of claim 1, wherein determining a numerical indicator for a candidate value comprises determining at least one of a count or a frequency of account operations of the first resource account that are associated with the candidate value.

8. The computing system of claim 1, wherein the account data for the first resource account includes identifying information for the accountholder and wherein the candidate values are determined based on the identifying information.

9. The computing system of claim 1, wherein selectively identifying the services comprises determining those services that are associated with one or more of the candidate values that satisfy defined criteria.

10. The computing system of claim 9, wherein the defined criteria comprise thresholds with which the numerical indicators are compared.

11. A processor-implemented method, comprising:
obtaining account data for a first resource account;
determining candidate values for at least one account attribute based on the account data for the first resource account;
determining, for each candidate value, a numerical indicator representing a degree of truth of the at least one account attribute having the candidate value;
selectively identifying services associated with the first resource account based on the numerical indicators; and
generating notifications of the identified services for presenting to an accountholder of the first resource account.

12. The method of claim 11, wherein the at least one account attribute comprises a country-of-origin of the accountholder and wherein the candidate values include a plurality of candidate countries.

13. The method of claim 11, wherein the account data for the first resource account includes operations data of past account operations associated with the first resource account and wherein determining the candidate values for the at least one account attribute comprises identifying values of the at least one account attribute for the past account operations based on the operations data.

14. The method of claim 13, wherein the operations data comprise historical transactions data representing at least one past transaction associated with the first resource account.

15. The method of claim 14, wherein the historical transactions data indicates a location associated with the at least one past transaction.

16. The method of claim 14, wherein the historical transactions data comprises merchant data of a merchant associated with the at least one past transaction.

17. The method of claim 11, wherein determining a numerical indicator for a candidate value comprises determining at least one of a count or a frequency of account operations of the first resource account that are associated with the candidate value.

18. The method of claim 11, wherein the account data for the first resource account includes identifying information for the accountholder and wherein the candidate values are determined based on the identifying information.

19. The method of claim 11, wherein selectively identifying the services comprises determining those services that are associated with one or more of the candidate values that satisfy defined criteria.

20. The method of claim 19, wherein the defined criteria comprise thresholds with which the numerical indicators are compared.
